(19) United States
(12) Patent Application Publication
(10) Pub. No.: US 2013/0098517 A1
(43) Pub. Date: Apr. 25, 2013

(54) WET AND SNOW TRACTION DESIGN FOR A TIRE TREAD

(71) Applicant: Cyril Guichon, Greer, SC (US)

(72) Inventor: Cyril Guichon, Greer, SC (US)

(73) Assignee: MRT, S.A. and STM, S.A.

(21) Appl. No.: 13/140,229

(22) PCT Filed: Jun. 30, 2010
(86) PCT No.: PCT/US10/40531

§ 371 Date: Jun. 16, 2011

(51) Int. Cl. B60C 11/04

(52) U.S. Cl. CPC B60C 11/04
USPC 152/209.8; 152/209.1

(57) ABSTRACT

A novel design for a high-speed tire tread is provided that gives improved performance in both water and snow conditions. The tread region of the tire uses transversely-oriented grooves that each extend in a novel manner across the width of the tread region. There are no grooves or other tread features that provide substantial fluid communication between the transversely-oriented grooves.

### FIELD OF THE INVENTION

The present invention relates to a novel design for a high speed tire tread that provides improved performance in both water and snow conditions using transversely-oriented grooves that each extend in a novel manner across the width of the tread region without grooves or other features that provide substantial fluid communication between such transversely-oriented grooves.

### BACKGROUND OF THE INVENTION

Road surfaces covered by rain or snow provide challenges to tire designers. Rain on a road surface can lead to a vehicle experiencing hydroplaning particularly at higher speeds. In general, hydroplaning occurs when the tire begins to push water in front of the tire as it travels down the road surface. When the pressure of the water pushing back against the tire is sufficient to lift the tire off the road, hydroplaning can occur and potentially lead to vehicle control problems. The pressure of the water is related to the depth of the water on the road surface and the speed of the tire relative to the road surface.

Tire designers have developed various features to combat hydroplaning. For example, conventionally grooves have been added to the tread pattern that extend along the circumferential direction around the tire to channel the water and prevent pressure build-up in front of the tire. Transverse grooves connected by these circumferential grooves may also be used to assist in evacuating water away from the front of the tire to the shoulders of the tire.

Snow on a road surface can also lead to a loss of traction particularly at higher speeds. Generally, snow can lead to a loss of friction or grip resulting in the tire sliding across the surface of the snow rather than rolling with traction. Various features have been developed to improve snow traction such as providing studs in the tread region and providing edges extending in the transverse direction in an effort to improve grip.

Efforts have also been made to provide tires for all season use that are capable of acceptable performance on dry, wet, and snow-covered surfaces. However, for high speed use in “on-road” conditions, conventional designs have resulted in trade-offs between rain and snow performance. By way of example, the addition of circumferentially-oriented grooves can improve traction on water covered surfaces (i.e. wet traction) but is deleterious to snow traction. Conversely, the addition of transversely-oriented grooves can improve snow traction but degrades wet traction in the absence of the circumferentially-oriented grooves. Thus, for high speed or “on-road” conditions, designers have typically had to compromise between wet and snow traction.

Accordingly, there is a need for a tire having a tread pattern designed for high speed, on-road use having improved performance on both snow and water covered road surfaces. More specifically, a tire having tread pattern that can provide improved performance in both rain and snow without the incorporation of circumferentially-oriented grooves would be very useful.

### SUMMARY OF THE INVENTION

Aspects and advantages of the invention will be set forth in part in the following description, or may be obvious from the description, or may be learned through practice of the invention.

In one exemplary embodiment, a tire for high speed, on-road use is provided having improved wet and snow traction. The tire defines transverse and circumferential directions and has a shoulder positioned along each side of the tire. The tire includes a tread region positioned between the shoulders of the tire. The tread region includes a plurality of transversely-oriented grooves extending between the shoulders of the tire and across the tread region. The plurality of transversely-oriented grooves are not connected by a groove or other feature that would provide fluid communication between the transversely-oriented grooves.

Each of these transversely-oriented grooves can include the following portions. First, a central portion can be provided at an overall angle in the range of about 15 degrees to about 50 degrees from the circumferential direction. Next, a pair of transition portions can be provided. Each transition portion is positioned in fluid communication with the central portion and is connected to the ends of the central portion. A pair of shoulder portions can also be provided. Each such shoulder portion is positioned in fluid communication with the central and transition portions. The shoulder portion is connected to outer ends of the transition portions and is located at least partly along the shoulders of the tire. One or all of the central, transition, and shoulder portions may be linear in shape.

In certain embodiments, the tire may also include a plurality of sipes extending between the plurality of transversely-oriented grooves. The sipes can also include a cavity for receipt of water or snow during operation of the tire.

In a particular embodiment, preferably the shoulder portions are oriented at angle in the range of about 75 degrees to about 90 degrees from the circumferential direction. Other angles may also be used. For example, the shoulder portions may also be oriented at angle in the range of about 80 degrees to about 90 degrees from the circumferential direction.

The central portion preferably includes a groove width in the range of about 3 mm to about 5 mm. Other widths may also be used to provide different embodiments.

A variety of shapes for the transversely-oriented grooves may be used to provide tread patterns of differing appearance. For example, in one exemplary embodiment, the plurality of transversely-oriented grooves may have a generally s-shaped appearance. As a further example, the plurality of transversely-oriented grooves have a generally chevron-shaped appearance.

Variances in the width of the transversely-oriented grooves may also be utilized in one or more of the central, transition, and shoulder portions. For example, the groove width of the transition portions can be shaped to increase in a direction moving away from the central portion towards the shoulder of the tire. Additionally, the groove width of the shoulder portions can be increased in a direction moving away from the central portion towards the shoulder of the tire. Other variances may also be used.

In order to provide additional traction performance improvements, additional features may also be used with the tire. For example, the tread region may be constructed from a flexible rubber composition so as to improve snow traction. The tread region can also include a plurality of extending between the plurality of transversely-oriented grooves and providing fluid communication therebetween, and the density of such sipes along the circumferential direction can be increased so as to improve snow traction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof; directed to one of ordinary skill in the art, is set forth in the specification, which makes reference to the appended figures, in which:

FIG. 1 illustrates an exemplary tread region that includes a representative, transversely-oriented groove with sipes according to an exemplary embodiment of the present invention. FIG. 1 is provided as a front view of a portion of the tread region of a tire. For purposes of clarity, only a single transversely-oriented groove is illustrated, it being understood that a plurality of such grooves is repeated along the circumferential direction C of the tire.

FIG. 2 illustrates a perspective view of another example of a tread region with transversely-oriented grooves and sipes according to another exemplary embodiment of the present invention.

FIGS. 3A-3D illustrates a schematic view of changes to a tread pattern as described more fully below.

### DETAILED DESCRIPTION OF THE INVENTION

For purposes of describing the invention, reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

As used herein, the following definitions apply.

“High speed” and/or “on-road” use means non-off road use at speeds that can include up to 60 kilometers per hour or more.

“Sipe” is used to refer to groove features in the tread that are 2 mm or less in width. During operation of the tire, a sipe in the contact patch is deformed and the sipe becomes either constricted or closed such that the movement of water through the sipe is insubstantial or even prevented.

“Groove” is used to refer to groove features in the tread that are greater than 2 mm in width. During operation of the tire, a groove in the contact patch will still provide substantially for the movement of water through the groove despite any groove deformation that may occur.

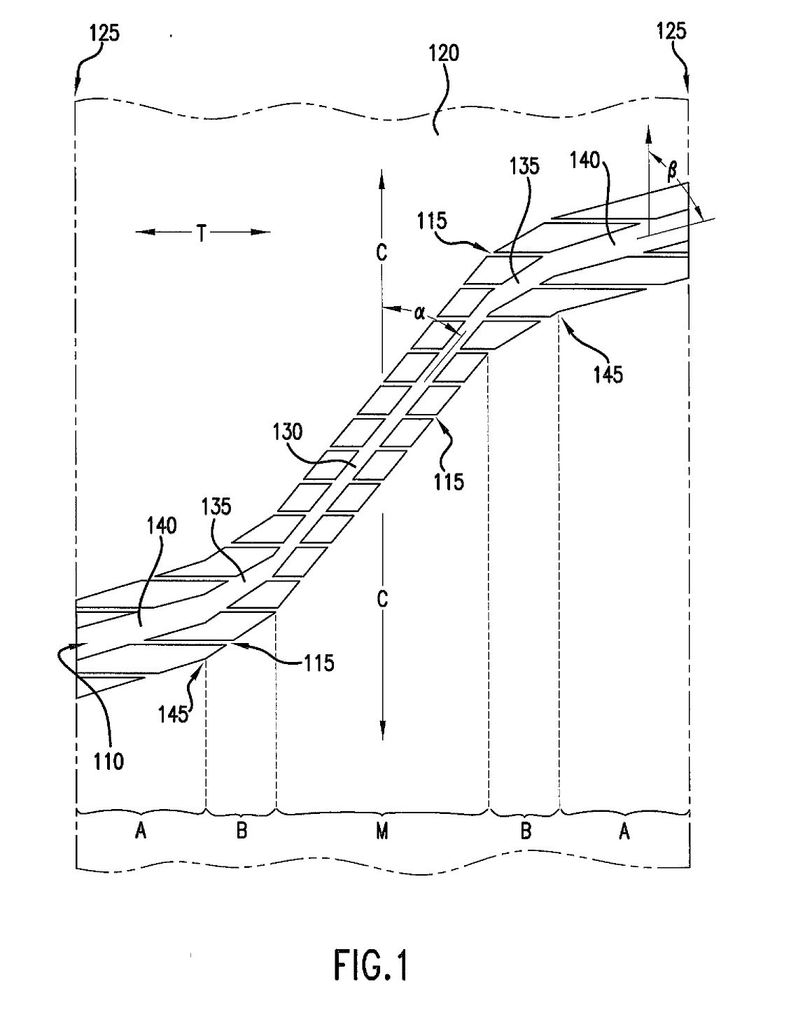

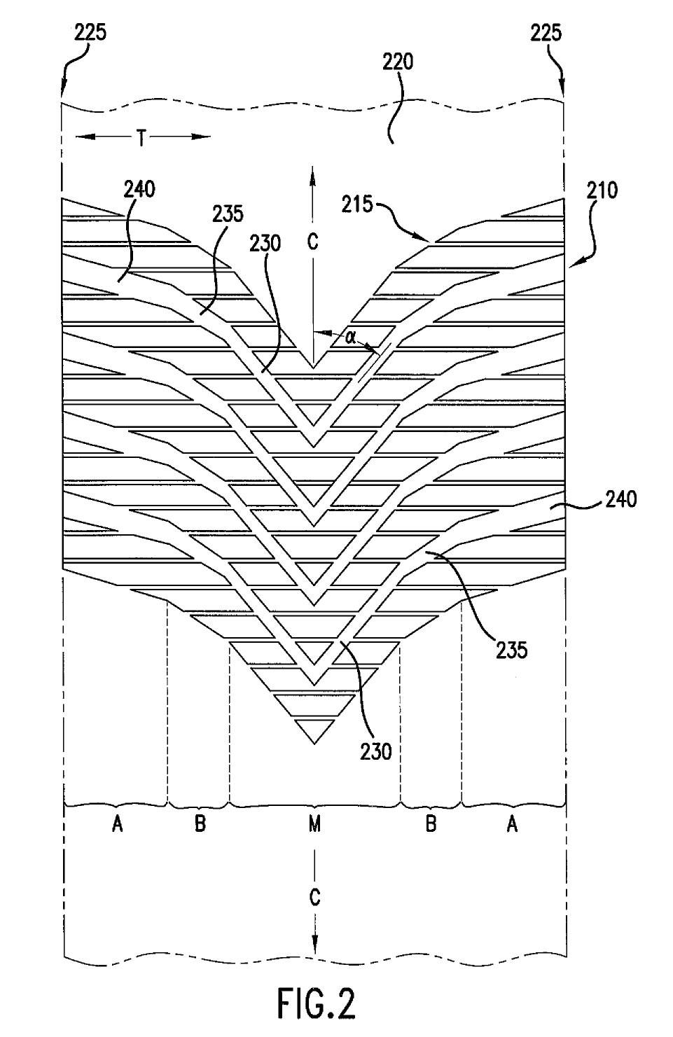

“Transverse” or “lateral” refers to the directions parallel to the axis of rotation of the tire and is designated with arrows T in FIGS. 1 and 2.

“Circumferential” refers to the circular direction defined by a radius of fixed length as it is rotated about the axis of rotation of the tire and is designated with arrows C in FIGS. 1 and 2.

As set forth above, tire designers have previously faced trade-offs between snow traction and wet traction (e.g., non-hydroplaning performance) in creating a tire tread. The addition of circumferentially-oriented grooves in order to improve wet traction unfortunately reduces snow traction. The addition of transversely-oriented grooves improves snow traction but a reduction in wet traction is experienced if circumferentially-oriented grooves are also applied. Among other aspects, the present invention provides a tire having a novel tread that provides improved wet and snow traction without the addition of grooves or other features connecting the transversely-oriented grooves so as to provide fluid communication between the transversely-oriented grooves.

FIG. 1 represents a groove 110 with sipes 115 according to an exemplary embodiment of the present invention. Groove 110 is oriented along the transverse direction of the tire as represented by arrows T. Groove 110 is located within the tread region 120 of a tire. Tread region 120 is positioned between the shoulders 125 of the tire. It should be understood that tread region 120 would comprise a plurality of transversely-oriented grooves 110 with sipes 115, and this plurality would be positioned along the circumferential directions C (indicated by arrows C). For the sake of clarity in the figures, only one such exemplary groove 110 is shown.

Transversely-oriented groove 110 includes a novel construction for improved wet and snow traction. More specifically, for the exemplary embodiment shown, groove 110 can be divided into three portions represented by brackets A, B, and M and referred to as central portion 130, transition portions 135, and shoulder portions 140. These portions are connected and are in fluid communication with each other as will be described.

Central portion 130 is positioned along the middle M of tread region 120 of the tire at an overall angle α from circumferential direction C. Angle α should be in the range of about 15 degrees to about 50 degrees from circumferential direction C. Tread regions with different angles α will be further discussed below. Additionally, preferably the width of groove 110 in central portion 130 is in the range of about 3 mm to about 5 mm. Central portion 130 is depicted as in linear in shape. However, other shapes such as wavy or undulating may be used as well. In such case, overall angle α refers to the overall direction or sweep of the groove relative to the circumferential direction C.

A pair of transition portions 135 are positioned about central portion 130 as indicated by brackets B. Each transition portion 135 is located along one side of central portion 130 and is connected to the ends of central portion 130. As such, transition portions 135 are in fluid communication with central portion 130 in that e.g., water encountered along a road surface can travel between central portion 130 and transition portions 135. For the exemplary embodiment of FIG. 1, the width of each transition portion 135 increases in a direction moving away from the central portion 130 and towards the shoulder 125 of the tire. In addition to what is shown in FIG. 1, other overall shapes and widths for transition portion 135 may be used as well.

A pair of shoulder portions 140 are positioned on the outer ends 145 of transition portions 135. More specifically, each shoulder portion 140 is located at least partly about a shoulder 125 of the tire and in tread region 120. Shoulder portions 140 are connected to transition portion 135 at outer end 145 and are in fluid communication with transition portion 135 and central portion 130. As such, water encountered along a road surface can travel between central portion 130, transition portions 135, and shoulder portions 140 and even exit tread region 120 in such manner.

Shoulder portion 140 of transversely-oriented groove 110 is positioned along the shoulder portion A of tread region 120 at an overall angle β from circumferential direction C. Angle β should be in the range of about 75 degrees to about 90 degrees from circumferential direction C. In addition, for the exemplary embodiment of FIG. 1, the width of each shoulder portion 140 increases in a direction moving away from the central portion 130 and towards the shoulder 125 of the tire. Shoulder portion 140 may include other shapes and widths different from that shown in FIG. 1. In such case, overall angle β refers to the overall direction or sweep of the groove of portion 140 relative to the circumferential direction C.

For the exemplary embodiment of FIG. 1, each portion 130, 135, and 140 of groove 110 is equipped with multiple sipes 115. As shown, sipes 115 are linear and oriented along the transverse direction T; other orientations and shapes may be used as well. Sipes 115 provide additional grip for traction as well as additional paths for the ingress and egress of fluid from a groove 110. Accordingly, sipes 115 allow for fluid communication between grooves 110. The density of sipes 115 along circumferential directions C can be increased in order to improve snow traction. Additionally, if desired, sipes 115 can also be provided with a cavity (not shown) for the receipt of snow or water during operation. It will also be understood that the selection of tread rubber used to construct tread region 120 can be adjusted to improve snow traction. For example, a more flexible rubber composition can be selected for the construction of tread region 120 in order to improve snow traction.

Notably, while a plurality of grooves 110 will be spaced through tread region 120 along circumferential direction C, grooves 110 are not connected to each other. More particularly, no groove or other feature is provided that would connect an individual groove 110 with another groove 110 so as to provide substantial fluid communication therebetween. Unlike many conventional tires, for example, there is no circumferentially-oriented groove or other tread feature in tread region 120 that connects groove 110 with another adjacent groove 110. Accordingly, fluid movement in groove 110 must be between portions 130, 135, and 140 and substantial fluid movement between adjacent groove 110 does not occur. For at least this reason, groove 110 provides improved wet and snow traction without the degradation of snow traction that would occur in the presence of a groove oriented along circumferential direction C.

As shown in FIG. 1, groove 110 overall has a generally s-shaped appearance and provides a tire having a non-directional tread pattern. However, it will be understood by one of skill in the art using the teachings disclosed herein that groove 110 can be used to created other pattern shapes. For example, referring now to FIG. 2 where similar reference numerals are used to indicate similar features, a tire with tread region 220 is depicted have a plurality of grooves 210 and sipes 215. As with groove 110, each groove 210 has a central portion 230, transition portion 235, and a shoulder portion 240 located along shoulder 225. However, grooves 210 create a generally chevron-shaped appearance and provide a tire have a directional tread pattern. It should be noted that the embodiment illustrated in FIG. 2 may be created by mirroring one half of the pattern shown in FIG. 1 about the mid-plane of the tire.

Again, other patterns can be created using different embodiments of the novel. transversely-oriented grooves of the present invention. By way of further example, groove 110 could be constructed with a central portion 130 extending across the entire width of the tread region 120 and without transition portions 135 or shoulder portions 140. Non-linear shapes for central portion 130 may also be used provided the grooves 110 are not connected in a manner that allows for substantial flow of water (i.e. fluid communication) therebetween.

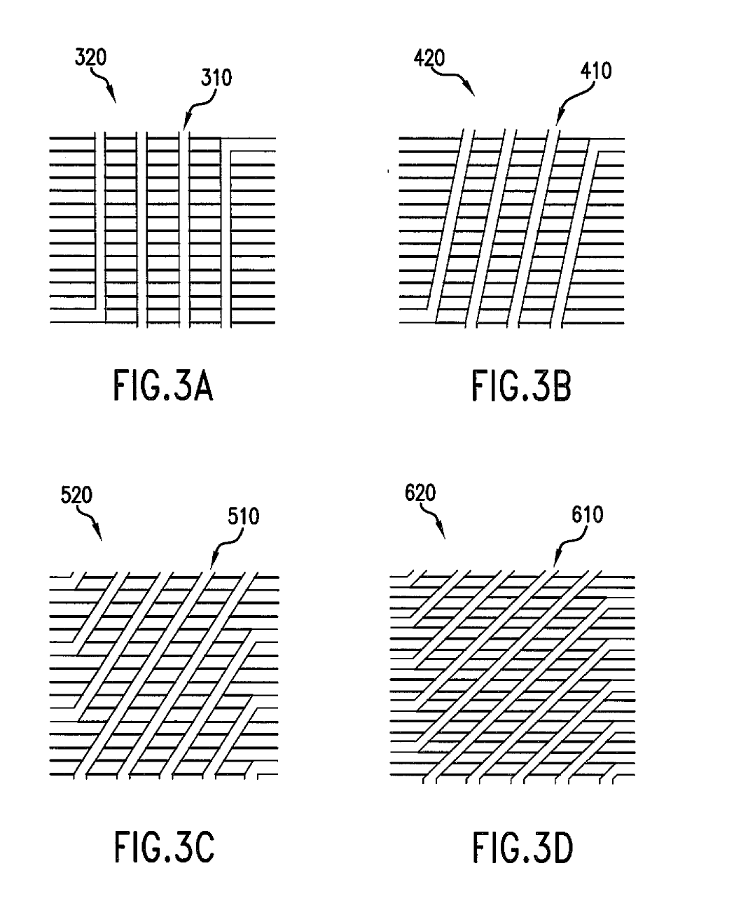

In order to ascertain the efficacy of certain aspects of the present invention, tread studies were performed with testing for wet and snow traction. FIGS. 3A through 3D schematically represent the tread regions 320, 420, 520, and 620 of tires that were tested. A tire size of 245/45R17 was used for the study. As shown in FIGS. 3A through 3D, each tread region has a plurality of transversely-oriented grooves 310, 410, 510, and 610 extending across the respective tread regions. Notably, tread region 320 represents a 0 degree (i.e. completely circumferential) orientation for groove 310. Tread region 420 represents 12 degrees, tread region 520 represents 30 degrees, and tread region 620 represents 45 degrees.

Each tread pattern was tested for hydroplaning performance using a test procedure that can be generally described as follows: Eight tires were constructed. At least two tires each were constructed having tread regions as schematically represented in one of FIGS. 3A through 3D such that a total of four pairs—each bearing one of these four patterns was provided.

The front wheels of a test vehicle having front wheel drive were then fitted with two tires—each having the same tread pattern. The test vehicle was driven through water having a depth of 8 mm on an asphalt track at a speed of 50 kph. Preferably, this speed was maintained by using e.g., cruise control on the vehicle. Once the vehicle reached the validation area, the driver accelerated the vehicle as quickly as possible for 30-50 in (this distance is fixed as desired) to see if 10% slip could be generated between the speed of the drive wheels and the GPS speed of the vehicle. If 10% slip was achieved, this same test run was repeated three more times. If 10% slip was not achieved, then the test run was performed by adding 5 kph to the initial vehicle speed. This step was then repeated until 10% slip was achieved. Once the 10% slip was achieved, then another three runs at the same conditions as previously described was conducted. Usually, five total runs were made with the first and last runs being used for reference only. Data is then acquired from these runs and a statistically relevant calculation of the speed at which hydroplaning occurs, which corresponds to the vehicle speed at which 10% slip happens, is constructed. Using this data, a performance measurement result was created.

Accordingly, Table 1 summarizes the results of testing for hydroplaning.

TABLE 1

| | | | | |
|---|---|---|---|---|
| Tread Region | 320 | 420 | 520 | 620 |
| Hydroplaning | 100 | 97 | 96 | 99 |

Pattern 320 is assigned a value of 100 since groove 310 is parallel to the circumferential direction and theoretically represents the best performance for this pattern. As demonstrated by the results, improved wet traction performance was achieved at an angle α of as high as 45 degrees from the circumferential direction. The result is substantial because conventionally it would be expected that wet performance would decrease as the transverse groove (410, 510 and 610) is oriented further away from a perfectly circumferential orientation as represented by groove 310.

Each tread pattern was also tested for snow traction performance using a test procedure that can be generally described as follows: An analytical measurement of the tire mu-slip curve is conducted under driving torque provided by a testing machine. In general, the mu-slip curve is represented by the coefficient of friction μ (mu) between the wheel and the running surface on a vertical axis and the slip ratio on the horizontal axis. The testing protocol involves the average μ (mu) measured during a 1.5 second interval after 2 mph DIV (40% slip). The track on which testing was conducted is a soft snow track with a CTI penetrometer value of around 85.

Table 2 summarizes the results of testing for snow traction.

TABLE 2

| | | | | |
|---|---|---|---|---|
| Tread Region | 320 | 420 | 520 | 620 |
| Snow Traction | 100 | 108 | 163 | 181 |

Pattern 320 was assigned a value of 100 for reference. As demonstrated by the date in Table 2, the snow traction performance dramatically increased as the angle of the transverse groove increased from the circumferential direction.

Accordingly, the transversely-oriented groove as described in the present invention provides a tire having improved wet and snow traction without unacceptable tradeoffs in performance between the two. In addition, as compared with conventional designs, the use of circumferentially-oriented grooves to provide improved wet traction (at the expense of snow traction) is avoided.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A tire for high speed, on-road use, the tire defining transverse and circumferential directions and having a shoulder positioned along each side of the tire, the tire comprising:
a tread region positioned between the shoulders of the tire, the tread region further comprising a plurality of transversely-oriented grooves extending between the shoulders of the tire and across the tread region, wherein said plurality of transversely-oriented grooves are not connected by a groove or other feature that would provide substantial fluid communication between said transversely-oriented grooves.

2. A tire for high speed, on-road use, as in claim 1, further comprising a central portion positioned at an overall angle in the range of about 15 degrees to about 50 degrees from the circumferential direction.

3. A tire for high speed, on-road use as in claim 2, wherein said central portion has a groove width in the range of about 3 mm to about 5 mm.

4. A tire for high speed, on-road use, as in claim 2, further comprising a pair of transition portions, each said transition portion positioned in fluid communication with said central portion and connected to ends of said central portion.

5. A tire for high speed, on-road use as in claim 4, wherein the groove width of said transition portions increases in a direction moving away from said central portion towards the shoulder of the tire.

6. A tire for high speed, on-road use, as in claim 4, further comprising a pair of shoulder portions, each said shoulder portion positioned in fluid communication with said central and transition portions, said shoulder portion connected to outer ends of said transition portions and located at least partly along the shoulders of the tire.

7. A tire for high speed, on-road use as in claim 6, wherein said shoulder portions are oriented at an overall angle in the range of about 75 degrees to about 90 degrees from the circumferential direction.

8. A tire for high speed, on-road use as in claim 7, wherein said shoulder portions are oriented at an overall angle in the range of about 80 degrees to about 90 degrees from the circumferential direction.

9. A tire for high speed, on-road use as in claim 6, wherein the groove width of said shoulder portions increases in a direction moving away from said central portion towards the shoulder of the tire.

10. A tire for high speed, on-road use as in claim 6, further comprising a plurality of sipes extending between said plurality of transversely-oriented grooves.

11. A tire for high speed, on-road use as in claim 10, wherein said sipes include a cavity for receipt of water or snow during operation of the tire.

12. A tire for high speed, on-road use as in claim 6, further comprising a plurality of sipes extending between said plurality of transversely-oriented grooves, and wherein the groove width of said transition portions increases in a direction moving away from said central portion towards the shoulder of the tire.

13. A tire for high speed, on-road use, as in claim 6, wherein said central portion is linear in shape.

14. A tire for high speed, on-road use as in claim 1, wherein each of said plurality of transversely-oriented grooves have a generally s-shaped appearance.

15. A tire for high speed, on-road use as in claim 1, wherein each of said plurality of transversely-oriented grooves have a generally chevron-shaped appearance.

16. A tire for high speed, on-road use as in claim 1, wherein the tread region is constructed from a flexible rubber composition so as to improve snow traction.

17. A tire for high speed, on-road use as in claim 1, wherein the tread region comprises a plurality of sipes extending between said plurality of transversely-oriented grooves, and wherein the density of said plurality of sipes along the circumferential direction is increased so as to improve snow traction.

18. A tire for high speed, on-road use as in claim 1, wherein the tread region comprises a plurality of sipes extending between said plurality of transversely-oriented grooves.
